(19) United States
(12) Patent Application Publication
(10) Pub. No.: US 2023/0182400 A1
(43) Pub. Date: Jun. 15, 2023

(54) SUPPORT STRUCTURE GENERATION FOR 3D PRINTED OBJECTS

(71) Applicant: HEWLETT-PACKARD DEVELOPMENT COMPANY, L.P., Spring, TX (US)

(72) Inventors: David MAZO FIGUEROLA, Sant Cugat del Valles (ES); Sandra MORENO DEL AGUILA, Sant Cugat del Valles (ES)

(73) Assignee: HEWLETT-PACKARD DEVELOPMENT COMPANY, L.P., Spring, TX (US)

(21) Appl. No.: 17/916,509

(22) PCT Filed: Apr. 6, 2020
(86) PCT No.: PCT/US2020/026849

§ 371 Date: Sep. 30, 2022

(51) Int. Cl. B29C 64/40; B29C 64/386; B29C 64/153

(52) U.S. Cl. CPC B29C 64/40; B29C 64/386; B29C 64/153; B33Y 40/20

(57) ABSTRACT

Support structure generation is described in which object model data relating to a plurality of three-dimensional objects to be printed by a three-dimensional printer may be obtained. A support structure such as a grid structure for supporting the objects during post-processing of the generated objects is generated. The grid support structure comprises a base portion printable in a substantially flat orientation and a connection element for releasably connecting each object to the base portion. The base portion comprises a flexible portion to enable the base portion that is printable in a substantially flat orientation to be formed into another configuration after printing without breakage of the base portion. Each object may be positioned on the base portion via a releasable connection element. Modified model data representing both the plurality of objects and the grid support structure, for printing by the additive manufacturing system, may then be obtained.

### BACKGROUND

Three-dimensional (3D) parts generated by an additive manufacturing process that may use a three-dimensional (3D) printing apparatus may be formed in a layer-by-layer manner in a build chamber of the 3D printing apparatus and, in one example, a part may be generated by solidifying portions of layers of build material. In other examples, 3D parts may be generated using extruded plastics or sprayed materials as build materials, which solidify to form a 3D printed part or object.

Following a build operation to generate printed parts in a 3D printing apparatus, the printed parts may be subjected to post-processing steps such as painting, polishing, metallisation, blasting and/ or cleaning. In order to carry out such post-processing steps, an operator may remove printed parts from a build chamber of the 3D printing apparatus and transfer them to a post-processing chamber.

### BRIEF DESCRIPTION OF THE DRAWINGS

FIG. 1 shows schematically an example of a support structure printable by a 3D printer.

FIG. 2 shows schematically a resulting 3D build after printing of the support structure of FIG. 1 and objects on the support structure in a generally flat configuration, according to an example.

FIG. 3 shows schematically one side view of a 3D build comprising two support structures including printed objects facing each other, according to an example.

FIG. 4 shows a view of an example support structure and objects after printing and bent into a cylindrical configuration to form a column structure for post processing.

FIG. 5 is a flowchart showing an example of a method for using a grid support structure.

FIG. 6 is a flowchart showing an example of a method for generating modified model data.

FIG. 7 shows an example controller configured to generate modified model data.

FIG. 8 shows an example of a computer readable medium comprising instructions to generate modified model data.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Additive manufacturing systems that are also referred to as three-dimensional, or 3D, printers may generate objects or printed parts based on structural design data. The phrases “additive manufacturing” and “3D printing” are used interchangeably in this patent specification. The phrases “additive manufacturing system”, “3D printer” and “three-dimensional printing apparatus” are also used interchangeably in this patent specification.

In general, with regard to 3D printing, the term “build material” is to be understood in the sense of a physical substance that can be used to generate an object. 3D printing is a process of making a three-dimensional solid or physical object of virtually any shape from a digital 3D model defined primarily in a certain format. The 3D model may be an object or objects to be created via 3D manufacturing processes during a printing operation. It may include a single object, multiple objects, an object fully enclosed in another object, or multiple objects in an interlocked and inseparable assembly.

One example 3D printing technique is selective laser sintering, in which selected parts of a layer of build material are sintered by the heating effect of a targeted laser beam. Another example 3D printing technique uses energy absorbing fusing agents for highly-localised control of the amount of energy from a radiation source which is absorbed by a build material, to control the temperature of selected parts of a layer of build material according to the presence of a fusing agent which promotes heat absorption and therefore fusing at selected locations. One example technique using a fusing agent is known as high speed sintering. In some fusing techniques, a detailing agent which has a cooling effect may also be used, to inhibit or modify fusing at chosen locations adjacent to the desired fusing. The example solution described in detail below is suitable for 3D printing techniques including these localised fusing and sintering examples, but can include other additive manufacturing techniques.

Suitable build materials for additive manufacturing include polymers, crystalline plastics, semi-crystalline plastics, polyethylene (PE), polylactic acid (PLA), acrylonitrile butadiene styrene (ABS), thermoplastic polyurethane (TPU), amorphous plastics, Polyvinyl Alcohol Plastic (PVA), Polyamide (such as polyamide (PA) 11, PA12), thermo(setting) plastics, resins, transparent powders, coloured powders, metal powder such as STEEL 316, ceramics powder such as for example glass particles, and/or a combination of at least two of these or other materials wherein such combination may include different particles each of different materials or different materials in a single compound particle. Examples of blended build materials include alumide, which may include a blend of aluminium and polyamide, multi-colour powder, and plastics/ceramics blends. According to one example, a suitable build material may be PA12 build material commercially referred to as V1 R10A ‘HR PA12’ available from HP Inc. There exist more build materials and blends of build materials that can be managed by example apparatuses disclosed herein and that are not mentioned in this disclosure.

In an example of the disclosure, the process of producing a 3D-printed object to a particular specification may include: (i) part and build preparation; (ii) 3D printing; and (iii) post-processing. During the part and build preparation, a digital model of objects to be printed, comprising object model data representing the objects, may be generated or received by a pre-print application.

The pre-print application may also receive or may generate data that defines a support structure suitable for supporting the objects during post-processing of the generated objects. The data may include parameters specifying the size and location of the support structure and may be determined manually by a user of the pre-print application. In some examples, parameters may be specified by a combination of manual and automatic processes, for example by the pre-print application generating a proposed support structure which may then be accepted, rejected or modified by the user. The support structure can be generated in the pre-print application in a substantially flat grid configuration with the grid configuration including rows in which objects to be printed can be positioned. Branches may be provided on the support structure and extend from a first surface of the support structure. Objects may be printed on and removably attached to the branches such that, after printing and post processing, an object can be removed from a branch. The objects to be printed may have a particular space volume which represents a volume occupied by the object.

A space may be provided between adjacent objects in a row of the support structure and the space may be sufficient enough to allow other similar sized objects having a similar space volume to the space to fit in a space between the adjacent objects, for example, if an object in another similar inverted support structure is positioned between the adjacent objects.

Digital models of objects to be printed, and associated supporting structure(s), may be packed into the available build volume, either manually or using an automated packing process, and such packing may be selected to minimise or make efficient use of build height in order to maximise the efficiency of the build process. Depending on the object and the spaces in the support structures, a number of support structures with objects can be arranged in a build volume with a first support structure being in a first orientation with objects attached to a surface of the first support structure via branches and a second support structure with objects attached to a surface of the second support structure via branches, the surface of the first support structure being arranged in a build volume to face the surface of the second support structure. The first orientation of the support structure could be considered face up whereas the second orientation is an inverted orientation and could be considered face down. The objects in the second support structure may be offset compared to the first support structure so as to fit in spaces between adjacent objects or another space adjacent an object in the second support structure.

Modified object model data can be generated representing both the objects and the support structure to be printed. The pre-print application may generate slices of the modified model data which may be sent to the printer for print data generation. Alternatively, the slices of the modified model may be extracted within the printer itself to generate printer control data. During 3D printing, the object(s) and support structure may be generated or printed by the 3D printer.

After the completion of the build operation in a 3D printer or other additive manufacturing system, printed objects may undergo post-processing steps in order to finish the objects to a particular specification. For example, in powder-based 3D printing processes, post-processing may include bead blasting of the printed parts to remove remaining powder on the part. Post-processing may also, for example, include chemical polishing of the printed parts to remove or alter surface layering and achieve a high level of surface smoothness, and/or may include painting, metallisation, or cleaning. Such post-processing steps may be conducted by an operator removing the printed parts from a build chamber of a build unit of the 3D printer, and transferring them to a post-processing chamber. According to the present disclosure, the transfer of parts can be achieved without the operator having to load individual printed parts onto a frame structure which is housed within the post-processing chamber during the post-processing operation.

The provision of the printed support structure may facilitate the handling of the printed object by an operator, for example when transferring the printed object, for example from the build unit, for example to a post-processing apparatus. In particular, where the build operation generates a plurality of individual objects, a printed support structure that supports all of these objects may enable an operator to easily transfer all objects from the build unit for post-processing by handling the support structure, rather than handling each object individually, and may also allow for optimised post-processing of the objects that are arranged on the support structure. In this case, the arrangement of the objects on the support structure may also serve to maintain a separation between individual objects during post-processing, thereby preventing individual objects from coming into contact and, for example, fusing together during post-processing.

According to the present disclosure, the support structure configuration is changeable from substantially flat as a result of the printing process to another shaped configuration that allows for post-processing of multiple objects that are connected to the support structure without having to remove the objects from the support structure. The support structure can be provided with structural characteristics to enable it's configuration to be changed after printing to facilitate post-processing.

In an example, the support structure may have a rectangular grid configuration and has flexibility so as to enable the support structure to be reconfigured from a flat configuration into a generally cylindrical configuration by bringing together and engaging two sides of the support structure. The reconfigured support structure may then have a column-like construction that enables a base of the column-like construction, for example, to be positioned on a surface and rotated in a post processing chamber. The support structure may also be provided with connection portions to allow the engagement of two sides of the support structure and to temporarily or permanently change the configuration of the support structure that supports the printed objects. In one example, the connections portions that may include a first portion on one side edge of the support structure and a second portion on a second opposite side edge of the support structure, the first portion being engageable with the second portion.

The support structure may be formed so as to enable it and the objects connected thereto to be simply placed in the chamber after printing, without the need to load individual objects connected to the support structure onto a separate frame in the chamber. In an example, the support structure may be arranged such that objects on the support structure extend outwards from a surface of the support. After bending from a substantially flat structure to form a column structure after printing, the objects can extend outwards on all sides of the column such that the objects can be exposed appropriately in a post-processing operation. In an example, the column structure could be rotated in a post-processing apparatus such as a bead blaster to enable automated bead-blasting. In another example, the column structure could be used in a chemical processing station to chemically polish/smooth, or to apply chemical coatings to the objects.

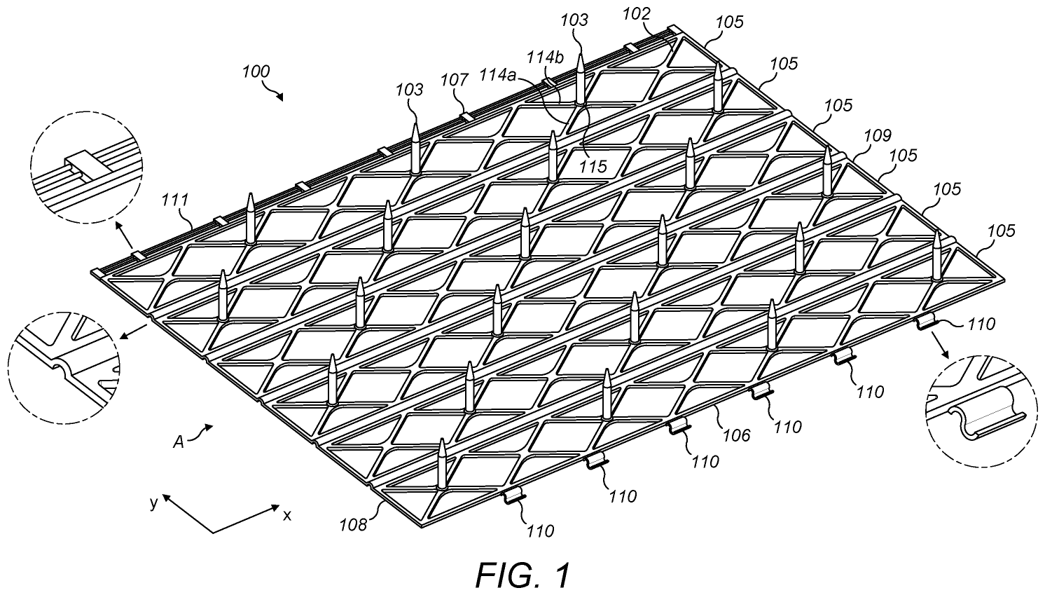

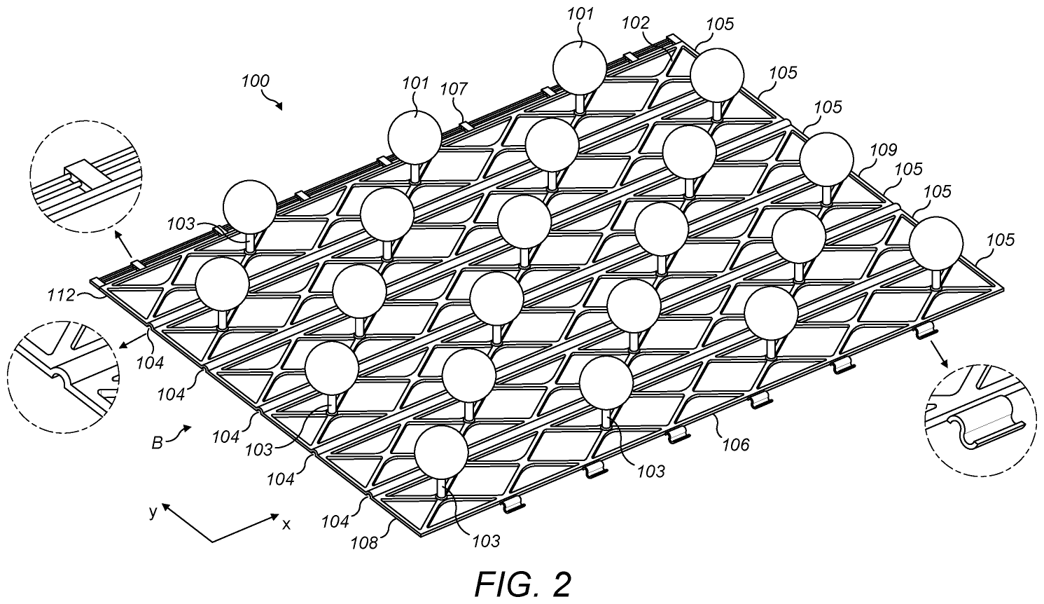

FIGS. 1 and 2 show an example of a support structure 100 that may be generated as part of 3D build data and 3D printed, in order to support an object 101 during post-processing. FIG. 1 shows the support structure without objects for clarity whereas FIG. 2 shows the support structure including the objects as would built by a 3D printer. In this example, the support structure 100 comprises a base portion 102 and a plurality of branches 103 that can connect the support structure base portion 102 to one or a plurality of objects. The branches 103 are upstanding from the base portion 102. The base portion 102 is in the form of a grid having a plurality of rows and branches 103 are arranged in each row. In this example, five rows and twenty one branches are depicted, but the disclosure is not limited to this number. The grid configuration may depend on the volume of the build chamber, the size/geometry of the objects being generated, and/or other parameters in relation to the 3D build. The dimensions of the support structure, including the number and dimensions of the branches, may be determined in such a way that the support structure base portion and branches are able to support the weight of the object and without breakage of the support structure when the structure is reconfigured from a flat configuration after printing to another shaped configuration for post processing. The objects 101 that are connected to the support structure 100 can be easily separated from the support structure 100 and the respective branch 103 to which they are connected once post-processing is complete.

In this example, the objects 101 are shown as generally spherical members but other shaped objects or configuration of objects could be printed with the support structure. The same generally spherical objects 101 are depicted in FIGS. 2 to 4 but, in other examples, there may be different objects printed on the same support structure.

The support structure base portion 102 is substantially flat after printing and comprises a flexible portion 104 to enable the support structure base portion 102 to be flexed after printing without breakage of the support structure base portion 102. The flexible portion 104 may have a different structural characteristic compared to other portions of the support structure base portion 102, so as to provide flexibility in the structure when the configuration of the support structure 100 is changed from a flat configuration to another configuration such as a cylindrical configuration for post processing. One example of the different structural characteristic may be the shape of the flexible portion 104. The flexible portion 104 extends substantially along a first longitudinal axis X of the support structure base portion 102. In some examples, the flexible portion may extend partially along the longitudinal axis X. In this example, as shown, there are a plurality of flexible portions 104 arranged parallel to each other and five flexible portions are depicted but the disclosure is not limited to this particular configuration or number. Each flexible portion 104 separates other portions 105 of the support structure base portion 102.

Each flexible portion 104 may have a corrugated profile forming, for example, an inverted U-shaped channel with ridges having peaks similar to a sine wave shape. The shape is such that it can provide flex without breakage of the grid structure base portion 102 when, after printing, two opposing side edges 106, 107 of support structure 100 are connected to reconfigure the support structure 100 from a flat configuration to a substantially hollow cylindrical configuration forming a column structure. In this example, the orientation and shape of the corrugated profile allows some extension of the base portion 102 and a degree of flexibility in the structure when the two opposing side edges 106, 107 of the support structure base portion 102 of support structure 100 are bent downwards from the flat configuration shown in FIG. 2.

In another example, the flexible portion may be a hinged member or other element to provide a degree of flexibility of movement of the support structure base portion without breakage of the base portion structure and allow for reconfiguration of the support structure after printing. Where the flexible portion is a hinged member, the other portions 105 of the support structure base portion may be bendable relative to the hinged member.

The type of build material used for building the 3D structure and thickness of the support structure base portion 102 may be selected to allow for more or less flexibility of the support structure. In examples as shown below in Table 1, the following material and thickness ranges can provide a desired flexibility to reconfigure the support structure from a flat configuration to a cylindrical column configuration.

TABLE 1
Example materials and thicknesses

| MATERIAL | THICKNESS (mm) |
|---|---|
| PA12 | 1-1.5 |
| TPU | 3-4.9 |
| STEEL 316 | 0.2-0.3 |

Referring again to FIGS. 1 and 2, the support structure base portion 102 comprises printable connector parts on opposing sides 106, 107 that allow engagement with each other after printing to form a column structure. In this example, the printable connector parts comprises a first connector part 110 and a second connector part 111, a first side 106 of the opposing sides of the support structure base portion 102 comprising the first connector part 110 and a second side 107 of the opposing sides of the support structure base portion 102 comprises the second connector part 111, the first connector part 110 and the second connector part 111 being formed to allow temporary engagement with each other after printing.

In this example, the first connector part 110 is a hook member and a plurality of hook members are spaced apart along the first side 106 of the support structure base portion 102. The second connector part 111 is a plurality of bars or rods extending along the second opposing side 107 of the support structure base portion 102 and parallel to the longitudinal axis X. The hook member is shaped such that it can engage with the plurality of bars or rods when the two connector parts are brought together. Both connector parts can be printed as part of the support structure. In other examples, other types of connector parts may be used to connect the two sides when forming the column structure and may be separate connectors not necessarily having been printed with the support structure.

The other portions 105 of the support structure base portion 102 correspond to the rows in the grid of the support structure base portion 102. Each other portion 105 forming a row in the grid comprises a lattice configuration formed of a plurality of elongate support struts extending in a repeating cross hatch orientation and pattern along a dimension that corresponds to the longitudinal axis X of the support structure base portion 102, and the or each branch 103 is located at an intersection point 115 of a pair of support struts 115a, 115b of the plurality of elongate support struts. In this example, there is a grid of five rows each containing seven pairs of support struts thus forming seven cross hatch structures that form part of the support structure base portion 102, but the disclosure is not limited to this number. The construction can provide sufficient strength to the support structure base portion 102 and objects 101 that are located on the branches 103 but also flexibility to enable the support structure configuration to be changed from a substantially flat configuration to a cylindrical configuration. In other examples, there may be other configurations or numbers of support struts or other support members forming part of the support structure base portion.

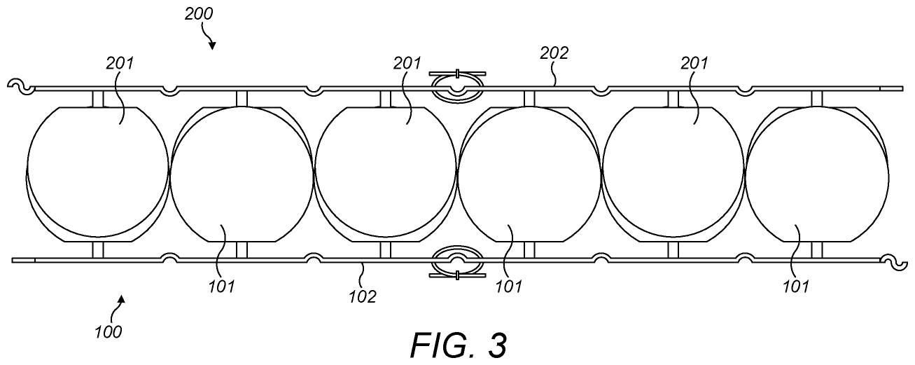

In this example, as shown in FIGS. 1 and 2, the branches 103 and the corresponding objects 101 connected thereto are provided on alternate pairs of support struts 115a, 115b in each row rather than on every pair of support struts 115a, 115b. There is therefore a space between adjacent branches 103 and adjacent objects 101 and the space may correspond to at least the area occupied by a pair of support struts 115a, 115b depending on a space volume of the branch 103 and the object 101. The area occupied by a pair of support struts 115a, 115b can be considered to represent a check in a checkerboard configuration such that the support structure represents a grid of a checkerboard and in this example, the checkerboard is a grid of seven by five. Using the analogy of the checkerboard, black boxes of the imaginary checkerboard will represent locations where an object is positioned and white boxes represent locations where there are spaces. The space between adjacent objects 101 in a respective row may be large enough such that at least a second object on another, second support structure can substantially be received in the space. This is described in more detail in relation to FIG. 3.

FIG. 3 shows an end view of an example of support structures that may be generated as part of 3D build data and 3D printed where two similar support structures have been stacked in a build volume. The support structures are the same as those in FIGS. 1 and 2 with a first support structure 100 comprising a plurality of first objects 101 in the orientation shown in FIGS. 1 and 2 and a second support structure 200 comprising a plurality of second objects 201 and being an inverted orientation of the first support structure 100. In this configuration, the support structures are oriented to face each other such that the top surface of the support structure base portion 102 of the first support structure 100 faces the top surface of the support structure base portion 202 of the second support structure 200. The objects in each support structure will be located in corresponding spaces in the other support structure. The spaces are those as described above in relation to FIG. 2. That is, both the plurality of second objects 201 and the second support structure 200 are arranged such that the each object of the plurality of the second objects 201 is substantially positioned either in a respective space between adjacent objects of the plurality of first objects 101 in a respective row of the first support structure 100 or a respective space adjacent an object of the plurality of first objects 101. The support structure 100 can be the same as the support structure 200 and can be stacked in pairs thereby providing efficient stacking of objects to be printing in a 3D printer but can also keep sufficient spacing between each object in a respective support structure for sufficient exposure of the objects in post processing when the support structures are separated from each other after printing and the objects on the support structures are post processed. In other examples, each object of the plurality of first objects is the same and each second object is the same or different to the each object of the plurality of first objects.

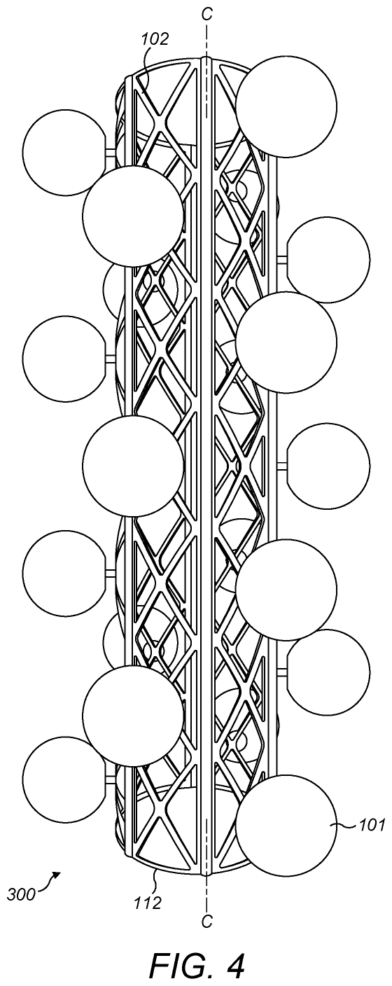

FIG. 4 shows a view of a grid support structure 100 having been reconfigured from a flat configuration that has resulted from 3D printing to a cylindrical column structure 300 by bringing together and attaching two sides of the grid support structure 100. The objects 101 are positioned around a central axis C-C of the column structure 300 and extend radially outwards from the support structure base portion 102. A base 112 of the column structure 300 can, for example, be positioned on a surface and rotated in a post processing chamber. Many different types of post processing operations such as painting, polishing, metallisation, blasting and/or cleaning may then be carried out manually or automatically.

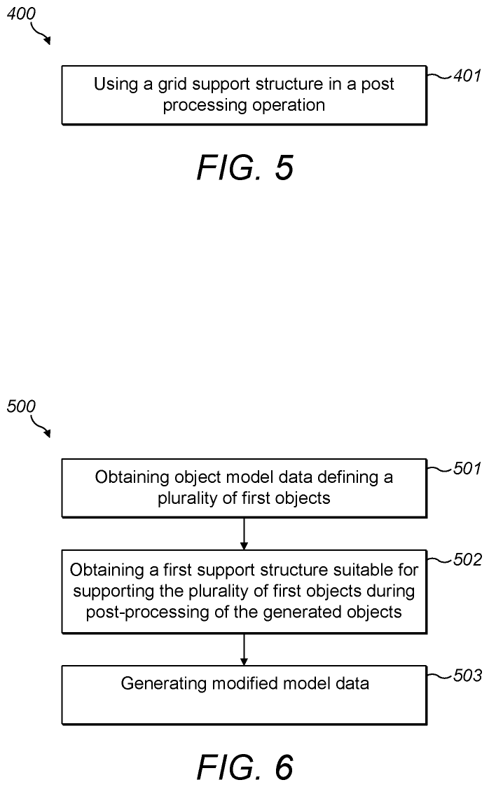

FIG. 5 shows an example of a method 400 comprising using 401 a grid support structure in a post processing operation, the support structure according to any of the examples described above and may comprise: a grid structure base portion three-dimensionally printed in a substantially flat orientation; and a releasable connection element releasably attaching each object of a plurality of objects to the grid structure base portion. Furthermore, the grid structure base portion may comprise a flexible characteristic to enable the base portion that is printed in the substantially flat orientation to be formed into a column structure for post processing without breakage of the grid structure base portion. Each part of the plurality of first parts can be positioned on the base portion via a respective releasable connection element.

FIG. 6 shows an example of a method 500 for generating printer control data comprising build data to control a 3D printer to generate objects and a support structure. The method comprises obtaining 501 object model data defining a plurality of first objects to be generated by a three-dimensional printing apparatus; and determining 502 a first support structure suitable for supporting the plurality of first objects during post-processing of the generated objects. The first support structure may be generated based on the plurality of first objects to be generated. A generated support structure may then be accepted, rejected or modified. In some examples, the support structure comprises a support structure base portion; and a branch for releasably connecting each object of the plurality of first objects to the support structure base portion, wherein the support structure base portion comprises a flexible portion to enable the base portion to be flexed after printing without breakage of the support structure base portion, and wherein each object of the plurality of first objects is positioned on the base portion.

At 503, modified model data is generated, representing both the plurality of first objects and the first support structure. This modified model data may be used to generate slices in a pre-print application which may then be transmitted to a 3D printer, or extracted within the printer itself.

In another example, stacking of a pair of support structure may be achieved. In such a case, the object model data further defines a plurality of second objects to be generated by a three-dimensional printing apparatus, the method further comprising obtaining the second support structure suitable for supporting the plurality of second objects during post-processing of the generated objects. The second support structure may comprise a second support structure base portion and a branch for connecting each object of the plurality of second objects to the support structure base portion. The second support structure base portion may similarly to the first support structure comprises a flexible portion to enable the second support structure base portion to be flexed after printing without breakage of the second support structure base portion, and each object of the plurality of second objects may be positioned on the second support structure base portion. The modified object model data may further represent both the plurality of second objects and the second support structure, for generation by the three-dimensional printing apparatus, and both the plurality of second objects and the second support structure are arranged such that the each object of the plurality of the second objects is substantially positioned either in a respective space between adjacent objects of the plurality of first objects in a respective row of the first support structure or a respective space adjacent an object of the plurality of first objects. The first and second objects may be the same, and the second support structure can be the same as the first support structure but in a different orientation—turned 180 degrees and inverted such that the pair of support structures face each other.

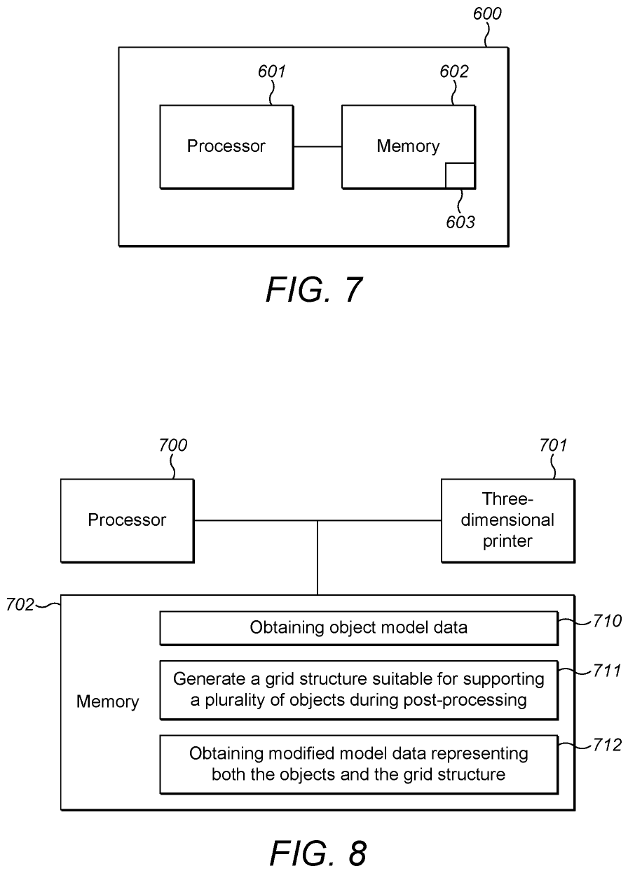

FIG. 7 shows an example of a controller 600 to generate printer control data. The controller 600 comprises a processor 601 and a memory 602. Stored within the memory 602 are instructions 603 for generating printer control data representative of objects and a grid support structure according to any of the examples described above. In one example, the controller 600 may be part of a computer running the instructions 603. In another example, the controller 600 may be part of a 3D printer to run the instructions 603 after obtaining object model data.

FIG. 8 shows a memory 702, which is an example of a computer readable medium storing instructions 710, 711, 712 that, when executed by a processor 700 communicably coupled to an additive manufacturing system, in this case a 3D printer 701, cause the processor 700 to generate printer control data in accordance with any of the examples described above. Instruction 710 is obtain object model data relating to parts to be printed by the three-dimensional printer. Instruction 711 is generate a grid structure for supporting the parts during a post-processing operation of the printed first parts, wherein the grid structure comprises: a grid structure base portion printable in a substantially flat orientation; and a plurality of releasable connection elements attached to the grid structure base portion and for releasably connecting each part to the grid structure base portion, wherein the grid structure base portion is formed to be flexible to enable the base portion that is printable in a substantially flat orientation to be reconfigured into a column structure with a cylindrical configuration after printing without breakage of the grid structure base portion by bringing two sides of the grid structure base portion together, and wherein each part to be printed is positioned on a respective releasable connection element. Instruction 712 is obtain modified model data defining both the parts to be printed and the grid structure, for printing by the three-dimensional printer. The computer readable medium 703 may be any form of storage device capable of storing executable instructions, such as a non-transient computer readable medium, for example Random Access Memory (RAM), Electrically-Erasable Programmable Read-Only Memory (EEPROM), a storage drive, an optical disc, or the like.

In addition to the examples described in detail above, the skilled person will recognize that various features described herein can be modified and/or combined with additional features, and the resulting additional examples can be implemented without departing from the scope of the system of the present disclosure, as this specification merely sets forth some of the many possible example configurations and implementations for the claimed solution.

1. A method comprising:
obtaining object model data defining a plurality of first objects to be generated by a three-dimensional printing apparatus;
determining a first support structure suitable for supporting the plurality of first objects during post-processing of the generated objects, wherein the first support structure comprises:
a support structure base portion; and
a branch for releasably connecting each object of the plurality of first objects to the support structure base portion,
wherein the support structure base portion comprises a flexible portion to enable the base portion to be flexed after printing without breakage of the support structure base portion, and wherein each object of the plurality of first objects is positioned on the base portion,
the method further comprising:
generating modified object model data representing both the plurality of first objects and the first support structure, for generation by the three-dimensional printing apparatus.

2. The method according to claim 1, wherein the support structure base portion is substantially flat and the flexible portion has a different structural characteristic compared to another portion of the support structure base portion.

3. The method according to claim 4, wherein the structural characteristic is the shape of the flexible portion.

4. The method according to claim 1, wherein there are a plurality of flexible portions extending in parallel along a first axis of the support structure base portion and that separate other portions of the support structure base portion.

5. The method according to claim 4, wherein the or each flexible portion includes a corrugated profile to provide flex without breakage of the grid structure base portion when, after printing, two opposing side edges of first support structure are connected to reconfigure the support structure from a flat configuration to a substantially (hollow) cylindrical configuration forming a column structure.

6. The method according to claim 4, wherein the other portions of the support structure base portion each form a row in the first support structure and the branches extend from the other portions to releasably connect each object of the plurality of objects to the support structure base portion.

7. The method according to claim 6, wherein each row comprises a lattice configuration formed of a plurality of elongate support struts extending in a cross hatch orientation along a dimension of the support structure base portion, and the or each branch is located at an intersection point of support struts of the plurality of elongate support struts.

8. The method according to claim 1, wherein the support structure base portion comprises printable connector parts on opposing sides that allow engagement with each other after printing.

9. The method according to claim 8, wherein the printable connector parts comprises a first connector part and a second connector part, a first side of the opposing sides of the support structure base portion comprising the first connector part and a second side of the opposing sides of the support structure base portion comprises the second connector part, the first part and the second part being formed to allow temporary engagement with each other after printing.

10. The method according to claim 1, further comprising: generating printer control data comprising instructions to control a three-dimensional printing apparatus to build the plurality of first objects and to build the first support structure; and controlling a three-dimensional printing apparatus to build the plurality of first objects and to build the first support structure based on the printer control data.

11. The method according to claim 11, wherein the first support structure is used to facilitate a post-processing operation on the plurality of first objects.

12. The method according to claim 6, wherein each object of the plurality of first objects is positioned in one of the rows on a respective branch of the support structure with a space between adjacent objects of the plurality of first objects in a respective row, such that at least a second object on a second support structure can substantially be received in the space.

13. The method according to claim 12, wherein the object model data further defines a plurality of second objects to be generated by a three-dimensional printing apparatus, the method further comprising:
obtaining the second support structure suitable for supporting the plurality of second objects during post-processing of the generated objects, wherein the second support structure comprises:
a second support structure base portion; and
a branch for connecting each object of the plurality of second objects to the support structure base portion,
wherein the second support structure base portion comprises a flexible portion to enable the second support structure base portion to be flexed after printing without breakage of the second support structure base portion, and wherein each object of the plurality of second objects is positioned on the second support structure base portion,
wherein the modified object model data further represents both the plurality of second objects and the second support structure, for generation by the three-dimensional printing apparatus, and both the plurality of second objects and the second support structure are arranged such that the each object of the plurality of the second objects is substantially positioned either in a respective space between adjacent objects of the plurality of first objects in a respective row of the first support structure or a respective space adjacent an object of the plurality of first objects.

14. A method comprising:
using a grid support structure in a three-dimensional printing post-processing operation, the grid structure comprising:
a grid structure base portion three-dimensionally printed in a substantially flat orientation; and
a releasable connection element releasably attaching each object of a plurality of objects to the grid structure base portion,
wherein the grid structure base portion comprises a flexible characteristic to enable the base portion that is printed in the substantially flat orientation to be formed into a column structure for post processing without breakage of the grid structure base portion, and wherein each part of the plurality of first parts is positioned on the base portion.

15. A non-transitory computer-readable medium comprising instructions, which when executed on a processor, cause the processor to:
obtain object model data relating to parts to be printed by the three-dimensional printer;
generate a grid structure for supporting the parts during a post-processing operation of the printed first parts, wherein the grid structure comprises:
a grid structure base portion printable in a substantially flat orientation; and
a plurality of releasable connection elements attached to the grid structure base portion and for releasably connecting each part to the grid structure base portion,
wherein the grid structure base portion is formed to be flexible to enable the base portion that is printable in a substantially flat orientation to be reconfigured into a column structure with a cylindrical configuration after printing without breakage of the grid structure base portion by bringing two sides of the grid structure base portion together, and wherein each part to be printed is positioned on a respective releasable connection element,
wherein the processor is further to:
obtain modified model data defining both the parts to be printed and the grid structure, for printing by the three-dimensional printer.
